(19) United States
(12) Patent Application Publication
(10) Pub. No.: US 2023/0239366 A1
(43) Pub. Date: Jul. 27, 2023

(54) SYSTEMS AND METHODS FOR DETERMINING A COMMUNICATION LOAD

(71) Applicant: Avaya Management L.P., Durham, NC (US)

(72) Inventors: Sandesh Chopdekar, Pune (IN); Pushkar Deole, Pune (IN); Navin Daga, Silapathar (IN)

(21) Appl. No.: 17/648,591

(22) Filed: Jan. 21, 2022

(51) Int. Cl. H04L 67/50; H04L 51/00; H04L 51/046

(52) U.S. Cl. CPC H04L 67/22; H04L 51/16; H04L 51/046

(57) ABSTRACT

A method for determining a communication load for a user including: monitoring at least one communication channel for one or more user activities; detecting at least one user activity related to one or more of a plurality of parameters, the plurality of parameters including a number of current communication sessions involving the user and an engagement level of the user in a meeting, in which the engagement level is a non-binary value and in which each of the parameters is associated with a weight; calculating, for a subset of the plurality of parameters, the communication load for the user based on the weight associated with each of the parameters within the subset; and automatically updating, based on the communication load, a display of a status indicator for the user by altering an appearance of the status indicator. Also disclosed is a corresponding system for determining a communication load.

### BACKGROUND

The present disclosure relates generally to systems and methods for determining a communication load for a user, and specifically to providing a dynamic display of a status indicator for the user based on the communication load.

With the recent increase in people working from home and other alternative workspaces, remote communication methods such as messaging systems, video calls, etc. have become important tools for communicating with supervisors, co-workers, family, and friends. A user may be engaged in multiple, simultaneous messaging sessions, in addition to attending virtual meetings, participating in conference calls, answering emails, etc. As a result, accurately reflecting the user's current status has taken on increased importance.

Most conventional messaging systems provide a basic indication of the user's status, e.g., “Busy,” “In a Meeting,” etc., which may be set by the user and/or automatically assigned by the system. However, this status is often binary and may not accurately reflect the user's actual communication load and availability. As the user's communication and/or work load increases, his or her response time for new messages, emails, phone calls, etc. may increase, but the user's status indicator may remain unchanged, i.e., “Busy.” In addition, the user's status may indicate that he or she is “In a Meeting,” but the user is not an active participant in the meeting and is available to respond to messages, emails, etc. In both scenarios, people attempting to reach the user do not know the user's actual availability.

### BRIEF SUMMARY

In accordance with one aspect of the present disclosure, a method for determining a communication load for a user comprises monitoring at least one communication channel for one or more user activities; detecting at least one user activity related to one or more of a plurality of parameters, the plurality of parameters comprising a number of current communication sessions involving the user and an engagement level of the user in a meeting, wherein the engagement level is a non-binary value and wherein each of the parameters is associated with a weight; calculating, for a subset of the plurality of parameters, the communication load for the user based on the weight associated with each of the parameters within the subset; and automatically updating, based on the communication load, a display of a status indicator for the user by altering an appearance of the status indicator.

In accordance with another aspect of the present disclosure, a system for determining a communication load for a user comprises a processor coupled to memory, wherein the memory includes a program that instructs the processor to perform: monitoring at least one communication channel for one or more user activities; detecting at least one user activity related to one or more of a plurality of parameters, the plurality of parameters comprising a number of current communication sessions involving the user and an engagement level of the user in a meeting, wherein the engagement level is a non-binary value and wherein each of the parameters is associated with a weight; calculating, for a subset of the plurality of parameters, the communication load for the user based on the weight associated with each of the parameters within the subset; and automatically updating, based on the communication load, a display of a status indicator for the user by altering an appearance of the status indicator.

### BRIEF DESCRIPTION OF THE DRAWINGS

FIG. 1 is a block diagram of a system, in accordance with the present disclosure;

FIG. 2 is a flow chart illustrating a process for determining a communication load of a user, in accordance with the present disclosure;

FIG. 3 provides an example of a status indicator in accordance with the present disclosure; and

FIG. 4 is a block diagram of a computer system having a computer readable storage medium for implementing functions, according to various aspects of the present invention, as described in greater detail herein.

### DETAILED DESCRIPTION

Systems and methods in accordance with the present disclosure determine a communication load for a user based on various user activity-related parameters and automatically updates a display of a status indicator for the user based on the communication load. The status indicator may be dynamic and may include degrees or gradations to more accurately reflect the user's actual communication load and availability. A model may be developed based on the parameters, and machine learning, including natural language recognition and processing, may be used to train the system to detect and analyze the parameters and more precisely calculate the user's communication load.

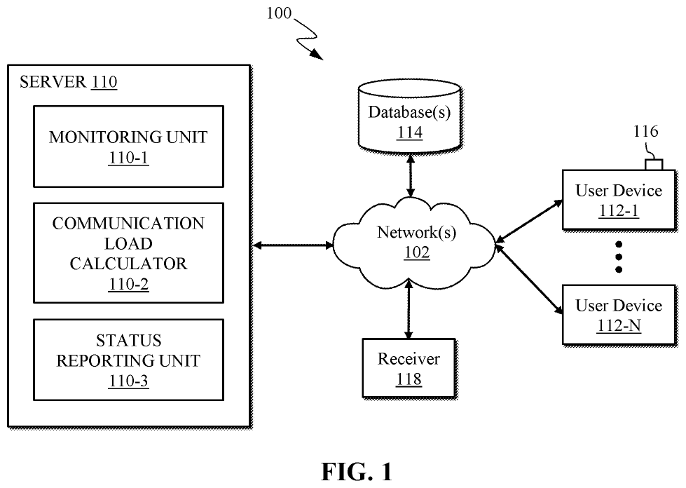

With reference to the drawings, FIG. 1 depicts a block diagram of a system 100 in accordance with the present disclosure. The system 100 may comprise a server 110, a set of one or more data stores or databases 114, and one or more user devices 112-1 to 112-N (referred to herein collectively as 112), all of which may be connected by one or more networks 102. The network 102 may comprise, for example, an intranet, a local area network (LAN), a wide area network (WAN), the Internet, or a combination thereof. The user device 112-1 to 112-N may include, but is not limited to, a desktop computer, laptop computer, tablet, smartphone, IP hardphone, IP softphone, a webcam, and the like. The user device 112 may also comprise one or more wearable devices, as described herein. The user device 112 and/or database 114 may be physically collocated with the server 110, and in other examples, the user device 112 and/or database 114 may be at a remote location that is physically separate from the server 110. It may be understood that the system 100 may comprise other servers (not shown), such as a web server, presence server, etc.

The system 100 may be an enterprise system and may be used in the context of a contact center or other enterprise with multiple employees. The system 100 may also be for personal (i.e., non-commercial) use. The database 114 may be used to store information related to the users and/or their associated user device(s) 112, as well as information about the enterprise and/or its customers (if applicable). The server 110 may comprise a unified communications server that receives and aggregates various user-related information. The server 110 may comprise, for example, a monitoring unit 110-1, a communication load calculator 110-2, and a status reporting unit 110-3. Although the monitoring unit 110-1, communication load calculator 110-2, and status reporting unit 110-3 are depicted as residing on the server 110, it may be understood that these components may be located in and/or implemented by one or more separate servers.

The monitoring unit 110-1 may comprise on or more managers, including a messaging manager, a meeting or conferencing manager, a device information manager, and/or a health information manager. The managers may each comprise one or more applications that gather and/or receive information related to various users and their associated user device(s) 112. The messaging manager may consolidate and manage multiple types, forms, or modalities of messages, such as voice mail, email, short message service (SMS) text message, instant message (IM), video call, and the like. The conferencing manager may facilitate meetings by connecting user devices 112 and managing the flow of media streams associated with the user devices 112 and/or one or more conferencing devices (not shown). The device information manager may receive and/or request device data from one or more user devices 112 associated with the user. The health information manager may receive and/or request health data from one or more wearable devices associated with the user. As described below, the communication load calculator 110-2 may calculate a communication load for a user based on information provided by the monitoring unit 110-1, and the status reporting unit 110-3 may update a display of a status indicator for the user based on the communication load.

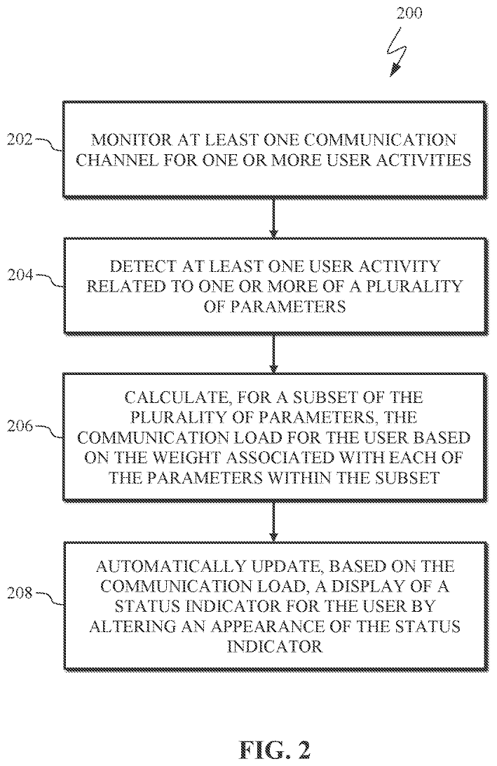

FIG. 2 is a flowchart that illustrates an exemplary method 200 for determining a communication load for a user in accordance with the present disclosure. The method 200 may be performed by one or more servers (e.g., server 110 in FIG. 1), one or more communication devices (e.g., user devices 112 in FIG. 1), or combinations thereof.

At 202, at least one communication channel is monitored for one or more user activities. A communication channel as used herein may include any medium through which a message is transmitted, including a text message (SMS and/or multimedia message service (MMS)), a phone call, a video call, an email, and the like. With reference to FIG. 1, the one or more managers associated with the monitoring unit 110-1 may monitor one or more of these communication channels for certain user activities. The user activity may include an interaction by the user with one or more input devices (not shown) associated with the user device(s) 112, such as a keyboard, touchscreen, touchpad, camera, microphone, etc. The user activity may also include information transmitted by the user device(s) 112, such as a location of the user and/or health data associated with the user, and/or information transmitted by an application associated with the user device(s) 112. The user activity may further include information related to the user and/or a communication session that is retrieved from the database 114 or other source.

For example, the messaging manager may monitor user activities on one or more communication channels associated with one or more applications, such as a chat or IM application, an email application, a social media application, a gaming application, etc. The application(s) may be stored on the user device 112, the server 110, and/or one or more separate host computers (not shown). In instances in which the application is not stored on the server 110, the information may be provided by an operating system (not shown) of the user device 112 and/or by an operating system of the host computer(s). An application programming interface (API) associated with an application may provide information regarding user activities related to that application. The one or more user activities may include, for example, logging into or out of an application, as well as application-specific activities, such as initiating or participating in a chat or IM session, preparing a new email or responding to a received email, and the like. In other examples, the messaging manager may also monitor one or more communication channels associated with incoming or outgoing voice and/or video calls involving the user.

The conferencing manager may monitor user activities on one or more communication channels, e.g., audio and/or video channels, associated with a conferencing application or platform and/or one or more conferencing devices (e.g., a device that handles documents, audio, and/or video for the meeting). The user activities may include, for example, sending a request to join or leave a conference, transmitting or receiving one or more media streams associated with the conference, sharing a document to the conferencing device, etc.

The device information manager may monitor one or more communication channels associated with one or more user devices 112 for certain device data that may be used to, for example, determine a location of the user. The device information manager may also monitor one or more communication channels, e.g., audio and/or video channels, for information regarding a background noise level at the user's location.

The health information manager may monitor one or more communication channels associated with the one or more wearable devices. The wearable device, e.g., user device 112-1, may comprise, for example, a device that is worn around the user's finger, hand, and/or arm (e.g., a watch, wristband, or arm band) or around another portion of the user's body. Using known methods, the wearable device may monitor one or more physiological parameters of the user, such as a pulse rate, blood pressure, temperature, and/or breathing rate, which may provide information about a current health status of the user. The wearable device may comprise a known structure and may include a transmitter 116 (e.g., a transmitting antenna) that periodically transmits information to a receiver 118 (e.g., a receiving antenna) associated with the monitoring unit 110-1. The receiver 118 may be wired or wireless and may be collocated with the server 110 or at a remote location.

At 204, at least one user activity related to one or more of a plurality of parameters is detected, in which each of the parameters may be associated with a weight, as described in detail herein. One or more communication channels may be monitored as described above, and using the data obtained from this monitoring, one or more user activities can be detected. The one or more managers associated with the monitoring unit 110-1 shown in FIG. 1 may detect the at least one user activity. Examples of the parameters are described below.

The plurality of parameters may include a number of current communication sessions involving the user, which may include voice, video, and/or text-based (e.g., chat, IM, or email) communications. The number of current communication sessions may include the number of communication sessions in which the user is concurrently or simultaneously participating. For example, it can be determined that the user is currently participating in two chat sessions, one email session, and one video phone call. A “current” or “active” communication session may be determined or inferred based on one or more factors related to the user and/or the user device(s) 112 associated with the user, such as an indication that the user is logged into a corresponding application and is presently transmitting and/or receiving data associated with the application and/or that the user has interacted with an input device (e.g., typing on a keyboard or touching a touchscreen) of the user device 112 within a predetermined time period while logged in; an indication that a phone line associated with the user is in use and/or that a real-time transcription is being performed for a call involving the user; an indication that the user device 112 is presently transmitting and/or receiving a media stream associated with a conference and/or that the user device 112 is physically located in a room for which a conference is currently scheduled, etc.

The plurality of parameters may include an inflow and/or outflow rate of messages to and from one or more applications and/or user devices 112 associated with the user within a predetermined time period. For example, it can be determined that within the predetermined time period, the user has received six messages and has sent five messages associated with a chat session; the user has received two voicemail messages; and the user has received two emails and has sent one email associated with an email session. An average message inflow/outflow rate for the predetermined time period may be determined for an individual user and/or for groups of users and may be set by the user and/or by a third party such as the user's supervisor or an administrator. In some examples, different types of communication sessions may be associated with different average message inflow/outflow rates, e.g., a chat session may have a higher average rate as compared to an email session.

The plurality of parameters may include a priority of a party involved in at least one of the current communication sessions. When it is determined that the user is involved in one or more communication sessions, additional information may be gathered about the communication session(s) and/or one or more parties to the communication session(s). The system may access the database 114 to determine an identity of a party and/or a priority associated with the party. The priority of the party may be provided by the user, and/or the priority of the party may be determined automatically by the system. In an enterprise setting, a party who is identified as being above the user within a hierarchy of the enterprise, such as a supervisor or director, may be associated with a higher priority. A customer may also be associated with a higher priority, while a co-worker/peer or subordinate may be associated with a lower priority.

The plurality of parameters may include a level of complexity of at least one of the current communication sessions. The level of complexity may be determined by analyzing a content of the communication using one or more known techniques. The complexity of a text-based communication session may be determined based on a variety of factors, such as a total word count, an average sentence length, an average number of characters and/or syllables per word, and/or a duration of the communication session, and may be determined across one or more messages associated with the text-based communication session. An audio communication session may be transcribed in real-time, and the transcript may be analyzed in a similar manner. The content of the communication session may also be analyzed for keywords indicating a sentiment of one or more of the participants. Exemplary techniques for analyzing a communication session may be found in U.S. Pat. No. 10,346,542, which is incorporated herein by reference. Alternatively, or in addition, a complexity of a communication session may be inferred, at least in part, based on a type of communication session, as some types of communication sessions will require more of the user's attention and focus than others. For instance, a phone call, a video call, or other real-time communication session may be considered more complex and higher intensity than, for example, an email session or other communication session that does not require real-time interaction by the user.

The plurality of parameters may include a current location of the user and/or a current level of background noise at the location. The user's location and level of background noise may be provided manually by the user and/or may be automatically determined by the device information manager based on information received from one or more user devices 112 associated with the user. For example, the user device 112 may transmit device data including its current physical location and/or other information that may be used to approximate a current location of the user device 112, such as a public IP address of a local server to which the user device 112 is connected. The user device 112 may periodically transmit the device data and/or may transmit the device data in response to instructions from the device information manager. The level of background noise may be determined based on, for example, information received from a microphone and/or camera associated with the user device 112.

The plurality of parameters may include an engagement level of the user in a meeting, in which the engagement level is a non-binary value. In some examples, the user may be leading the meeting or may otherwise have an active role in the meeting (e.g., as a moderator or note taker), in which case the user's engagement level may be relatively high. In other examples, the user may have only a small role in the meeting (e.g., as a speaker for only one segment of a lengthy meeting) or may be an entirely passive participant in the meeting, in which case the user's engagement level may be relatively low. In further examples, the user's schedule may indicate that he or she has a scheduled meeting, but the user did not attend the meeting or the meeting was delayed or canceled. Many conventional systems do not gather any information beyond determining whether the user's schedule indicates that the user is in a meeting, such that the user's engagement level would be deemed the same in all of the above-described examples. In particular, the user's engagement level in these conventional systems would be assigned a binary value, e.g., either “In a Meeting” or “Available.” As described herein, determining the user's actual engagement level in the meeting as a non-binary value can help to provide a more accurate reflection of the user's communication load and availability.

In some instances, the engagement level of the user may be provided manually by the user (e.g., by indicating that his or her role is to lead the meeting). In other instances, the engagement level of the user may be automatically inferred, at least in part, based on information retrieved from the database 114 and/or received from one or more devices. The user's level of engagement may be deduced based on the user's position or title and/or a position or title of other participant(s) in the meeting. For example, when the user is a supervisor and the other participants are subordinates, it can be inferred that the user may be leading the meeting or otherwise will have a high level of engagement. Alternatively, or in addition, the user's level of engagement may be inferred based on a type of meeting and/or number of participants. For example, the user is likely to have a low level of engagement in a large, company-wide meeting but may have a higher level of engagement in a topic-focused meeting with a smaller number of participants.

In further instances, the engagement level of the user may be determined based on information received from one or more user devices 112 associated with the user, one or more user devices 112 associated with other users attending the same meeting, and/or one or more conferencing devices associated with the meeting. An audio and/or video stream from the user device(s) 112 and/or conferencing device(s) may be analyzed to determine, for example, a number of active speaking instances by the user and a number of times that the user is mentioned by other meeting participants. The media stream(s) may also be used to determine other information, such as, how often a camera and/or microphone are oriented toward the user, whether the user is sitting still or moving (e.g., typing notes, changing slides), etc.

The plurality of parameters may include one or more physiological parameters associated with the user. As described above, one or more wearable devices associated with the user may monitor one or more physiological parameters such as the user's blood pressure, pulse rate, etc. and transmit this information to the receiver 118. The wearable device may periodically transmit the information at predetermined time intervals and/or may transmit the information in response to a request from the health information manager. The health information manager may analyze a signal received from the wearable device and extract information related to the one or more physiological parameters associated with the user.

At 206, the communication load for the user is calculated for a subset of the parameters, in which the communication load is based on the weight associated with each of the parameters within the subset. The communication load calculator 110-2 shown in FIG. 1 may perform the calculation based on one or more rules, as described below. The rules may be stored, for example, in the database 114.

In some examples, the subset of parameters may include one or more, but less than all of the parameters, and in other examples, the subset may include all parameters. In some instances, the subset of parameters may be determined, at least in part, by the user. The user may provide the system 100 (FIG. 1) with instructions to customize the subset of parameters to include and/or exclude one or more parameters. For example, the user may be going on a business trip and may wish to include a current location as one of the parameters within the subset. The user may also wish to exclude certain parameters, such as physiological parameters, from consideration. The user may further wish to customize the parameters based on the day and/or time of day, e.g., to include certain parameters only on days and/or during the hours that the user is scheduled to work. In some examples, the subset of parameters may be fully customizable by the user, such that the user could potentially exclude all parameters.

In other instances, a third party may at least partially determine the subset of parameters. For example, a supervisor or administrator may determine one or more of the parameters that are included in the subset. At least some of the parameters may be fixed so that the user cannot alter whether the parameters are included in, or excluded from, the subset. In further instances, the subset of parameters may be automatically determined or selected based on user information, such as a title and/or role of the user. The system 100 (FIG. 1) may optionally create a profile for the user, which may be used to store information relating to the title and/or role of the user and may be stored in the database 114 (FIG. 1). The profile may include, for example, an indication of the user's job title, e.g., software developer, engineer, sales, consultant, etc., and may also include the user's position within a hierarchy of the enterprise, e.g., director or supervisor, entry-level employee, mid-level employee, etc. The profile may also include an indication of the user's role or job function, such as a list of tasks for which the user is responsible, along with other relevant information about the user, such as the user's education level and degrees, certificates, years of experience, etc. The parameters included for a certain user may be determined, at least in part, based on this user information, as certain parameters may be more or less relevant for certain job titles and/or roles. For example, the current location of the user may be more relevant for users with certain titles or roles that are associated with frequent travel, while the number of current communication sessions may be more relevant for users that are in a customer service role.

Each of the parameters may be associated with a weight that is used to calculate the user's communication load by the communication load calculator 110-2 in accordance with one or more rules. For example, the weight of a parameter may comprise a value or range of values assigned to the parameter, e.g., via a point system, and a total number of points may be added up to calculate the user's communication load. In general, as the user's communication load increases, the user's ability to focus and respond quickly will likely decrease, and adjusting the number of points may provide a more accurate reflection of the user's communication load. Calculation of the communication load may be performed using one or more models developed based on machine learning, and the model(s) may be adapted and improved over time to more accurately calculate the communication load.

In one simple example, each parameter within an exemplary subset of five parameters may be assigned a weight comprising a value of 1 point, and the communication load may be calculated on a scale of 1 to 5, with 1 being the lowest and 5 being the highest.

In more complex examples, one or more of the individual parameters may be assigned a weight comprising a range of values to provide an indication of the user's communication load at a more granular level. The value within this range that is assigned to a particular parameter may be determined based on one or more properties associated with that parameter, as described below.

For example, the parameter comprising a number of current communication sessions involving the user may be associated with a value ranging from 1 to 5 points, with the number of points being correlated to a number of concurrent communication sessions, e.g., 1 point may be associated with one to two current communication sessions, 2 points may be associated with three to four current communication sessions, and so on, with a corresponding increase in the overall communication load.

The parameters comprising the message inflow/outflow rate, a priority of a party, and/or a complexity of one or more of the current communication sessions may likewise affect the communication load and may be assigned a value range. When the user's message inflow/outflow rate is higher than average, the number of points and the corresponding communication load may be higher and vice versa. The user may need to be more focused and attentive when communicating with his or her supervisor or with a valued customer, which would warrant a higher number of points and a corresponding higher communication load, while a communication session with a peer or subordinate may result in a lower number of points. The user may also need to be more focused and attentive when handling one or more complex communication sessions as described above, which would warrant a higher number of points and a higher communication load. In some examples, the message inflow/outflow rate, the priority of the party, and the complexity of the one or more communication sessions may each be assigned a separate weight. In other examples, one or more of these parameters may be factored into the above-described parameter associated with the number of communication sessions. In the above example in which the number of concurrent communication sessions is associated with a value of 1 to 5 points, the user may currently be engaged in only one communication session but the communication session is associated with a higher than average message inflow/outflow rate, involves a high priority person, and/or is of greater complexity, in which case the rules may indicate that the parameter should be assigned 2 points instead of 1 point.

The parameter comprising a current location of the user may be assigned a range of values based on, for example, a level of background noise at the user's current location. In some examples as described herein, the noise level may be determined directly using a microphone in a user device 112 associated with the user. In other examples, the noise level may be inferred based on the user's location. For instance, when the user's current location indicates that the user is at an airport or traveling in a car, it may be inferred that the noise level will be relatively high, e.g., above a certain decibel threshold. This higher noise level may make it difficult for the user to, for example, hear a phone call and may warrant a higher value and a correspondingly higher communication load. If the user's current location indicates that the user is at his or her workplace, then it may be inferred that the noise levels will be relatively low, which may result in a lower value and a lower communication load.

When the user is in a meeting, the user's communication load may be determined based on his or her engagement level in the meeting and the corresponding associated range of values. For example, when the user is leading or otherwise has an active role in the meeting, it can be inferred that the user has a high level of engagement, and a higher value may be assigned for this parameter, which would result in a correspondingly higher communication load. A lower value may be assigned when the user has a lower level of engagement, e.g., when the user has a more limited role in the meeting. As described above, the user's engagement level may be indicated manually or may be inferred based on, for example, the user's position/title, a position/title of other participants in the meeting, the type of meeting, the number of participants, information received from one or more user and/or conferencing devices, etc.

The physiological parameters associated with the user may be associated with a range of values based on a change in the user's physiological parameters. For example, one or more of the user's physiological parameters may be compared to a corresponding standard range for persons within the user's demographic. Alternatively, or in addition, the user's physiological parameters may be compared to a baseline range for that user. An increase in pulse rate, blood pressure, temperature, and/or breathing rate can generally be associated with an increase in stress level and/or may be an indication that the user is sick or not feeling well. A value may be assigned based on, for example, an amount of deviation from the standard or baseline range(s). For instance, an increase in blood pressure of 5 mm Hg above the standard/baseline range(s) may be assigned 1 point, an increase of 10 mm Hg may be assigned 2 points, and so on, with a corresponding increase in the user's communication load.

In some examples, each parameter within the subset may be assigned the same value, e.g., 1 point, or range of values, e.g., 1 to 5 points. In other examples, a relative weight of one or more of the parameters within the subset may be fully or partially customizable so that one or more parameter(s) play a relatively greater or lesser role in determining the user's communication load. Similar to the selection of parameters for inclusion in the subset of parameters, the relative weight may be adjusted by the user and/or by the user's supervisor or other third party and/or may be automatically determined by the system 100 (FIG. 1) based on, for example, the title and/or role of the user as described above. For example, in a five-parameter system where parameters are generally associated with a value of between 1 to 5 points (e.g., 25 total points), a user in a managerial position may generally attend more meetings but is less likely to wear a device that sends health data. Thus, the parameter regarding the user's engagement level in a meeting may be associated with a relatively larger number of points, e.g., 3 to 7 points, while the parameter associated with health data may be associated with a relatively smaller number of points 1 to 3, such that the parameter associated with the user's engagement level in a meeting plays a greater role in determining that particular user's communication load. The overall weight of a parameter may also be increased or decreased by multiplying the value by a factor of 0.5×, 2×, etc. As noted above, calculation of the communication load may be performed using one or more models developed based in machine learning, and the model(s), including the relative weight of parameters within the subset, may adjusted and improved over time.

At 208, a display of a status indicator for the user is automatically updated, based on the communication load, by altering an appearance of the status indicator, after which the method may conclude. The status indicator may provide an indication of the user's communication load. The status reporting unit 110-3 shown in FIG. 1 may communicate with the communication load calculator 110-2 and map the calculated communication load with the appropriate status indicator based on one or more rules, which may be stored in the database 114. The status reporting unit 110-3 may also communicate with one or more components of the system 100, such as a presence server (not shown), to ensure that the user's status indicator is reflected correctly across other components of the system 100. The status indicator may be displayed on a screen of one or more of the user devices 112 to ensure that other users are aware of the user's current communication load and availability.

In most conventional systems, a status indicator with a green color and/or a descriptor such as “Available” may be used when the user is completely free, i.e., the user is not participating in any communication sessions or attending a meeting, while a red color and/or a descriptor such as “Busy” or “In a Meeting” may be used to indicate that the user is engaged in at least one activity or is attending a meeting. However, there typically is no intermediate status indicator between these two extremes, which prevents other users from knowing the user's actual communication load and availability. A status indicator in accordance with the present disclosure provides a more accurate reflection of the user's actual communication load, in which an appearance of at least a portion of the status indicator may be altered based on the communication load calculated for the user.

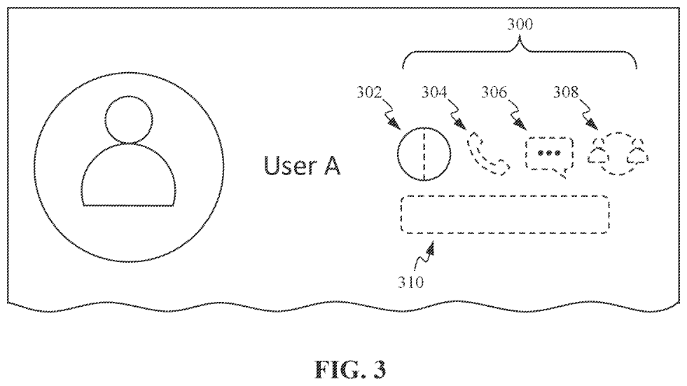

With reference to FIG. 3, an exemplary status indicator 300 for User A is depicted, in accordance with the present disclosure. The status indicator 300 may comprise one or more elements having different shapes, such as a circle 302 and/or an icon representing a telephone 304, a message 306, and/or a meeting 308. The telephone icon 304 may represent any kind of phone call, including audio only or audio and video. The message icon 306 may represent any kind of text-based communication session, including chat, IM, email, etc. The meeting icon 308 may represent an in-person or virtual meeting. As described below, one or more additional icons are contemplated. The status indicator 300 may optionally comprise one or more descriptors 310 in the forms of word(s) or phrase(s). The appearance of the status indicator 300 may comprise a color and/or a shape of the circle 302 and/or icons 304, 306, 308, as well as a content of the descriptor 310.

In some examples, the rules may provide one or more threshold values, and the status reporting unit 110-3 may compare the calculated communication load to the threshold value(s) to determine how the appearance of the status indicator 300 should be altered. In the simple example provided above in which the communication load is calculated on scale of 1 to 5, a value of 1 point may be associated with a low communication load, a value of 2 points may be associated with a moderately low communication load, a value of 3 points may be associated with a moderate communication load; a value of 4 points may be associated with a moderately high communication load; and a value of 5 points may be associated with a high communication load. For ease of discussion, the following description focuses on the simple example. However, it is understood that threshold values may similarly be provided for more complex examples in which each parameter is assigned a range of values.

Each calculated communication load may be associated with one or more colors, in which the color of at least a portion of the status indicator 300 may be updated to reflect the calculated communication load, and/or a particular content of the descriptor 310. With reference to the circle 302 and the descriptor 310 in FIG. 3, a value of 1 point may be associated with the circle 302 having a solid green color and/or the descriptor 310 of “Available,” and a value of 5 points may be associated with the circle 302 having a solid red color and/or the descriptor 310 of “Very Busy.” One or more colors associated with values in between 1 and 5, i.e., 2 to 4, may be used to reflect the degrees or gradations within the calculated communication load. For example, a value of 2 points, i.e., moderately low, may be reflected by the circle 302 having one half, e.g., the left half as indicated by the dashed line, that is green and the other half, e.g., the right half, that is yellow and/or the descriptor 310 of “Slightly Busy.” Alternatively, the circle 302 may have a gradient of green changing to yellow or may be a solid color that is a mix of green and yellow, e.g., chartreuse. A value of 3 points, i.e., moderate, may be reflected by the circle 302 being half green or yellow and half orange, having a gradient of green or yellow changing to orange, or having a solid color that is a mix, e.g., light orange, and/or the descriptor 310 of “Moderately Busy.” A value of 4 points, i.e., moderately high, may be reflected by the circle 302 being half orange and half red, having a gradient of orange changing to red, or being a mix, e.g., dark orange, and/or the descriptor 310 of “Busy.” Although the circle 302 is shown in FIG. 3 as having a vertical line dividing the circle 302 into right and left halves, it is understood that the circle 302 could also have, for example, a horizontal line dividing the circle 302 into upper and lower halves.

In some examples, instead of the circle 302, the status indicator 300 may comprise one or more of the icons 304, 306, 308 (with or without the descriptor 310), in which a color of at least a portion of the icon(s) 304, 306, 308 may be altered as described above to reflect the calculated communication load. In other examples, the status indicator 300 may comprise the circle 302 plus one or more of the icons 304, 306, 308, in which a color of the circle 302 and/or the icon(s) 304, 306, 308 may be altered to reflect the calculated communication load. In both examples, the one or more icons 304, 306, 308 may be selected by the status reporting unit 110-3 (see FIG. 1) based on one or more detected user activities. For example, when the user is in a meeting, the status indicator 300 may include the meeting icon 308; when the user is engaged in a phone call, the status indicator 300 may include the telephone icon 304; and/or when the user is engaged in a text-based conversation, the status indicator 300 may include the message icon 306 (alone or in addition to the circle 302). Additional icons (not shown) may be used in place of, or in addition to, the circle 302 and/or icons 304, 306, 308 depicted in FIG. 3 to reflect one or more additional user activities. For example, an airplane or car icon may indicate that the user is traveling, a heart icon may indicate that the user is wearing a wearable device that monitors physiological parameters of the user, etc. A content of the descriptor 310 may also be updated to reflect, for example, “Traveling.”

The system 100 may receive, from a second user device associated with a second user, a request to initiate a new communication session with the user (referred to in this context as a first user). In some examples, the system 100 may, in response to receiving the request, compare the communication load of the first user to a predetermined threshold and may take different actions based on whether the communication load is below the threshold or is at or above the threshold. The predetermined threshold may be determined by the first user, by a third party, and/or automatically by the system in accordance with the one or more rules. The predetermined threshold may be associated with an individual user or with a group of users, e.g., all users within a certain department or group, and may be determined, at least in part, by a context of the communication load, including the type of communication session the second user is seeking to initiate, the type of communication session(s) in which the first user is currently involved, and/or the one or more parameters used to calculate the communication load and the weight(s) associated therewith.

When the communication load is below the threshold, the system 100 may establish the new communication session. When the communication load is at or exceeds the predetermined threshold, the system 100 may either decline the request or queue the request. The queued request may be stored for a predefined period of time, which may be determined by the first user, by a third party, or automatically by the system. For example, if the first user knows that he or she will be in a meeting for an hour, the first user may choose to have all requests queued for an hour. Upon expiration of the predefined period of time, the communication load of the first user may again be compared to the threshold, and if the first user's communication load is below the threshold at that time, the new communication session may be initiated. If the first user's communication load still exceeds the threshold, the request may be queued again or dropped.

In response to receiving the request to initiate a new communication session, the system 100, e.g., the messaging manager (FIG. 1) may optionally provide one or more messages to the second user device, in accordance with one or more rules, which may be stored in the database 114. In one example, the message may comprise an indication regarding the first user's communication load, e.g., moderate, and may indicate a delay in a response by the first user. In another example, the message may comprise instructions for the second user to contact the first user via a different messaging channel. For instance, if the second user is seeking to initiate a phone call with the first user and the first user is in a noisy location or is in a meeting, the message may suggest that the second user contact the first user via a text-based communication mode such as chat or email. In either example, the message may provide the second user with the option to proceed with initiating the communication session via the original communication mode or via a different communication mode. In a further example, when the system queues or declines the request to initiate a new communication request, the messaging manager may send a message to the second user device indicating that the request has been declined or that the request has been queued and will be attempted again at a later time.

A decision whether to send a message and/or a content of the message may be determined based, at least in part, on the comparison of the communication load to the predetermined threshold and/or the context of the communication load, as discussed above. The second user may be seeking to initiate a phone call with the first user, and in one example, the first user is participating in three chat sessions with a moderate communication load that is below the threshold. Thus, the system may establish the communication session and may determine that a message to the second user is not warranted or that a message indicating a response delay is appropriate. In another example, the first user may already be participating in a phone call. Because a person generally cannot participate in two simultaneous phone calls, the system may queue or decline the call and may send a message indicating that the call has been queued or declined. Depending on the first user's communication load, the system may optionally send a message suggesting that the second user contact the first user via a text-based communication mode. In a further example, the first user may be in a very noisy location, such that first user's status indicator reflects a high communication load, but the first user is not otherwise engaged in any communication sessions. The system may similarly queue or decline the call and may send one or more messages indicating that the call has been queued or declined and/or suggesting that the second user contact the first user via a text-based communication mode.

The first user may optionally provide instructions to the system 100 comprising one or more user preferences for receiving notifications regarding requests to initiate a new communication session. For example, whenever the system 100 sends a message to the second user device in response to receiving a request to initiate a new communication session, the system 100 may send a notification to the first user, in accordance with the user preferences. The notification may include, for example, identifying information of the second user, a time and date of the request, a communication mode of the request (e.g., chat session, phone call, etc.), a content of the message, and/or a disposition or resolution of the request (e.g., queued or declined by the system, the second user opted not to proceed with the request, etc.). The user preferences may include a preferred notification mode, such as text message or email, and/or a desired notification frequency. In some instances, the first user may wish to immediately receive notifications, and in other instances, the first user may wish to receive notifications periodically. For example, the first user may instruct the system 100 to hold all notifications for a predetermined time, and following expiration of the predetermined time, the system 100 may send a single notification to the first user regarding any request(s) received during the predetermined time. In all instances, these notifications inform the first user of who has attempted to contact them and may serve as a reminder to the first user to follow up with the second user.

The system 100 may generate a report, e.g., via the status reporting unit 110-3, relating to the communication load for a plurality of users over a defined time period. For example, a supervisor may wish to determine a communication load of employees under his or her supervision and may transmit a request for the system to generate a report providing the communication load for these employees over a certain time period, e.g., one week, one month, etc.

### EXAMPLES

The following examples are made with reference to the status indicator 300 shown in FIG. 3, in which User A is a new employee who was recently hired as a software developer. In all of the following examples, the monitoring unit 110-1 (FIG. 1) monitors one or more communication channels for one or more user activities by User A and detects at least one user activity by User A related to one or more of a plurality of parameters, as described herein. The communication load calculator 110-2 (FIG. 1) calculates a communication load for User A based on information provided by the monitoring unit 110-1, and the status reporting unit 110-3 (FIG. 1) updates a display of the status indicator 300 for User A based on the calculated communication load.

In a first example, User A is engaged in a chat session with each of Users B, C, and D. User B is User A's supervisor, and the conversation with User C involves a complex topic and involves the exchange of a large number of messages. User D is one of User A's work colleagues who is also a new employee. User A's status indicator 300 may comprise the message icon 306 and/or the circle 302, in which a color of the circle 302 and/or the message icon 306 may be, for example, half green and half orange to indicate that User A's communication load is moderate due, at least in part, to the higher priority of User B and the complexity and higher message inflow/outflow rate of the conversation with User C. User A's status indicator 300 could also include a descriptor 310 of “Moderately Busy.” User E wishes to initiate a new chat session with User A, but after viewing User A's status indicator 300, User E knows that User A is somewhat busy and may choose to send User A an email or wait until User A's status indicator 300 indicates that User A's communication load is lower. If User E chooses to initiate the new chat session with User A, the system may determine that User A's communication load is still below a predetermined threshold and may establish the chat session but may provide a message to User E's device indicating that User A's communication load is moderately high and that there may be a delay in a response by User A.

In a similar example, User A is engaged in the same chat sessions with Users B, C, and D, except that User A is wearing a device that monitors his or her blood pressure and pulse rate and the health data received from the device indicates that User A's blood pressure and pulse rate are elevated. Thus, User A's status indicator 300 may comprise a heart icon (not shown) in place of, or in addition to, the message icon 306 and/or the circle 302. A color of the heart icon, message icon 306, and/or circle 302 may be half orange and half red and User A's status indicator 300 could also include a descriptor 310 of “Busy,” due, at least in part, to the addition of the health data from User A's device. After viewing User A's status indicator 300, User E knows that User A is busy and is somewhat stressed or not feeling well. User E may choose to delay contacting User A or to contact User A via a different mode. If User E chooses to initiate the new chat session to User A, the system may determine that User A's communication load is above the predetermined threshold and may decline or queue the chat request. The system may also send a message to User E's device suggesting that User E contact User A via email and/or indicating that the chat session has been declined or queued.

In a similar example, User A is again engaged in chat sessions with Users B, C, and D, except that Users B, C, and D are all User A's work colleagues who are new employees and none of the conversations involve complex topics. Thus, User A's status may comprise the circle 302 and/or the message icon 306, in which the color of the circle 302 and/or the message icon 306 may be half green and half yellow and/or the descriptor 310 may be “Slightly Busy” to indicate that User A's communication load is moderately low. User E wishes to call User A, and after viewing User A's status, User E knows that User A is not very busy and places the call to User A. The system may determine that User A's communication load is below the predetermined threshold and may establish the call, with no message(s) being sent to User E's device.

In a second example, User A is engaged in a phone call with User B and chat sessions with each of Users C and D, in which Users B, C, and D are all User A's work colleagues who are new employees and none of the conversations involve complex topics. User A's status indicator 300 may comprise the telephone icon 304 and message icon 306, and optionally the circle 302, in which the color of the circle 302, telephone icon 304, and/or the message icon 306 may be half orange and half red to indicate that User A's communication load is moderately high due, at least in part, to the phone call with User B occupying more of User A's attention and focus. User A's status indicator may also include a descriptor 310 of “Busy.” User E wishes to call User A, but after viewing User A's status, User E knows that User A is quite busy and also that at least one phone line associated with User A is occupied with the call to User B. Thus, User E may choose, for example, to send an email to User A or initiate a new chat session with User A. If User E still chooses to place the call to User A, the system may determine that User A's communication load is above a predetermined threshold and may decline or queue the call. The system may also send a message to User E's device suggesting that User E contact User A via email and/or indicating that the call has been declined or queued.

In a third example, User A may be in the first of two meetings. User A's status indicator 300 may comprise the meeting icon 308, and optionally the circle 302. The first meeting is a large, quarterly meeting of all software developers in the company that is taking place virtually, in which User A is a passive participant. In this case, the color of the circle 302 and/or the meeting icon 308 may be half green and half yellow and/or the descriptor 310 may be “Slightly Busy” to indicate that User A's level of engagement in the meeting is low. User B wishes to call User A. After viewing User A's status indicator 300, User B knows that User A is in a meeting and may not answer a phone call. However, User A's status indicator 300 indicates that User A is not that involved in the meeting, so User B initiates a new chat session with User A. The system may determine that User A's communication load is below the predetermined threshold and may establish the chat session, with no message(s) being sent to User B's device.

The second meeting is a one-hour, in-person meeting between User A, a few other new software developers, and their supervisor, in which User A is an active participant. User A speaks often during the meeting, and other participants have mentioned User A's name several times. In this case, the color of the circle 302 and/or the meeting icon 308 may be solid red and/or the descriptor 310 may be “Very Busy” to indicate that User A's level of engagement in the meeting is high. User C wishes to initiate a new chat session with User A, but after viewing User A's status indicator 300, User C knows that User A is very busy and may choose to wait before trying to contact User A. If User C chooses to initiate the new chat session, the system may determine that User A's communication load is above the predetermined threshold and may decline or queue the chat request. The system may also send a message to User C's device informing User B that the request has been declined or that the request has been queued for one hour until the meeting is over.

In a fourth example, User A is waiting at the airport to leave for a business trip but is otherwise not engaged in any communication sessions. User A's status indicator 300 may include an airplane icon (not shown), and optionally the circle 302. Audio from User A's device indicates that the background noise level at User A's location is high, which would make a phone call difficult to hear. Thus, the color of the circle 302 and/or the airplane icon may be half orange and half red to indicate that User A has a moderately high communication load, due at least in part to the noise level at User A's current location. User A's status indicator 300 may also include a descriptor 310 of “Busy.” User B wishes to call User A, but after viewing User A's status indicator, User B knows that User A is on travel and appears to be quite busy. If User B chooses to initiate the phone call, the system may decline or queue the call and may send a message to User B′s device informing User B that the call has been declined or queued. Because User A's communication load is high due solely to background noise at User A's location, the system may also send a message suggesting that User B contact User A via chat or email.

A system in accordance with the present disclosure provides an intelligent and adaptive mechanism for more accurately calculating and reflecting a user's current communication load in the context of a communication system, such as an enterprise communication system or a private chat system. For example, the system may be trained, using natural language recognition and processing, to recognize the voice of the user to more accurately identify when the user is speaking, when the user is mentioned by another participant, etc. The system may use machine learning to perform many of the processes described herein, including associating a user's title or role with certain parameters and/or to adjusting the weight of certain parameters based on the user's title or role. The system may also use machine learning to determine normal, baseline physiological parameters for a certain user in order to more accurately correlate changes in these physiological parameters with increased stress, as well as learning to associate certain locations with higher noise levels and determining the best response to provide to others who are seeking to reach the user at a noisy location. The system may further use machine learning to determine communication load thresholds for individual users or groups of users and the best way to respond to requests to initiate new communication sessions when the threshold is exceeded.

These processes provide for a better overall experience and increase efficiency within the system. The user need not worry about expending computing resources and taking time away from productive activities to ensure that his or her status indicator is accurate and up-to-date. Likewise, those seeking to communicate with the user can make the best use of their time and computing resources by sending communications to the user via an appropriate communication channel and/or at a time when the user is most able to view the information and/or respond in a timely manner. In this manner, the system limits disturbances to the user and optimizes use of system resources by filtering and/or redirecting requests to initiate communication sessions with the user.

Further, the methods and systems described herein represent an improvement in the technology of communications systems, particularly for large enterprises. As indicated above, the system can suppress or redirect communication requests sent to the user's device during times when the user cannot respond or will likely reject the request. As a result, the number of unsuccessful communication requests traversing the system, i.e., communication requests that never result in an established communication link, may be reduced. A total duration of the communication sessions may also be reduced, as the system can defer establishment of the communication session to a time when the user is less busy or is otherwise able to respond in a timelier manner. Reducing the number of unsuccessful communication requests and/or the total duration of communication sessions will lead to a reduction in overhead processing power (and corresponding energy draw). Therefore, the processing power that would have been devoted to handling these unsuccessful communication requests and/or maintaining these lengthier communication sessions can be put to better use (e.g., in processing other communications requests that will result in a communication link).

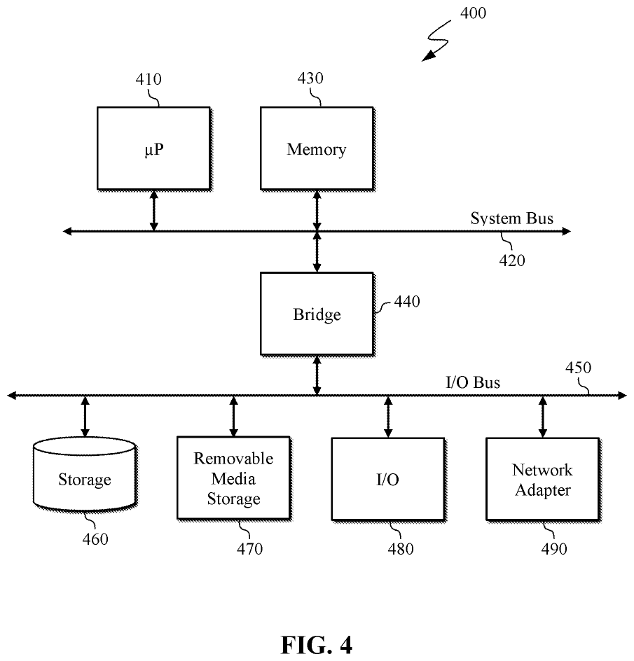

Referring to FIG. 4, a block diagram of a data processing system is depicted in accordance with the present invention. Data processing system 400 may comprise a symmetric multiprocessor (SMP) system or other configuration including a plurality of processors 410 connected to system bus 420. Alternatively, a single processor 410 may be employed. Also connected to system bus 420 is local memory 430. An I/O bus bridge 440 is connected to the system bus 420 and provides an interface to an I/O bus 450. The I/O bus may be utilized to support one or more buses and corresponding devices, such as storage 460, removable media storage 470, input/output devices (I/O devices) 480, network adapters 490, etc. Network adapters may also be coupled to the system to enable the data processing system to become coupled to other data processing systems or remote printers or storage devices through intervening private or public networks.

Also connected to the I/O bus may be devices such as a graphics adapter, storage and a computer usable storage medium having computer usable program code embodied thereon. The computer usable program code may be executed to implement any aspect of the present invention, for example, to implement any aspect of any of the methods and/or system components illustrated in FIGS. 1-3.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using a Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

1. A method for determining a communication load for a user, the method comprising:
monitoring at least one communication channel for one or more user activities;
detecting at least one user activity related to one or more of a plurality of parameters, the plurality of parameters comprising a number of current communication sessions involving the user and an engagement level of the user in a meeting, wherein the engagement level is a non-binary value and wherein each of the parameters is associated with a weight;
calculating, for a subset of the plurality of parameters, the communication load for the user based on the weight associated with each of the parameters within the subset; and
automatically updating, based on the communication load, a display of a status indicator for the user by altering an appearance of the status indicator, wherein the appearance of the status indicator comprises at least one color associated with the communication load calculated based on the weight associated with each of the parameters within the subset.

2. The method of claim 1, wherein the user comprises a first user, the method further comprising:
receiving, from a user device associated with a second user, a request to initiate a new communication session with the first user; and
in response to receiving the request, providing, to the user device associated with the second user, a message regarding the communication load of the first user, wherein the message comprises one or more of an indication of a delay in response and instructions to contact the user via a different messaging channel.

3. (canceled)

4. The method of claim 1, further comprising:
comparing the communication load of the user to a predetermined threshold; and
when the communication load is at or exceeds the predetermined threshold, declining or queueing a request to initiate a new communication session with the user.

5. The method of claim 1, wherein the plurality of parameters further comprises at least one of a priority of a party involved in at least one of the current communication sessions, a complexity of at least one of the current communication sessions, or a current location of the user.

6. The method of claim 1, further comprising:
receiving, from at least one wearable device associated with the user, health data related to a current health status of the user, wherein the plurality of parameters further comprises information related to one or more physiological parameters extracted from the health data.

7. The method of claim 1, wherein an engagement level of the user in a meeting is determined based on one or more of a role of the user in the meeting, a number of active speaking instances by the user, and a number of times the user is mentioned by another participant.

8. The method of claim 1, further comprising:
creating a profile for the user, the profile comprising at least one of a title or a role of the user; and
determining, based on the profile, the subset of the plurality of parameters.

9. The method of claim 1, further comprising:
receiving, from the user, instructions to customize the subset of the plurality of parameters.

10. The method of claim 1, wherein the user comprises one of a plurality of users, the method further comprising:
generating a report relating to the communication load for the plurality of users over a defined time period.

11. A system for determining a communication load for a user, the system comprising:
a processor coupled to memory, wherein the memory includes a program that instructs the processor to perform:
monitoring at least one communication channel for one or more user activities;
detecting at least one user activity related to one or more of a plurality of parameters, the plurality of parameters comprising a number of current communication sessions involving the user and an engagement level of the user in a meeting, wherein the engagement level is a non-binary value and wherein each of the parameters is associated with a weight;
calculating, for a subset of the plurality of parameters, the communication load for the user based on the weight associated with each of the parameters within the subset; and
automatically updating, based on the communication load, a display of a status indicator for the user by altering an appearance of the status indicator, wherein the appearance of the status indicator comprises at least one color associated with the communication load calculated based on the weight associated with each of the parameters within the subset.

12. The system of claim 11, wherein the user comprises a first user and wherein the program further instructs the processor to perform:
receiving, from a user device associated with a second user, a request to initiate a new communication session with the first user; and
in response to receiving the request, providing, to the user device associated with the second user, a message regarding the communication load of the first user, wherein the message comprises one or more of an indication of a delay in response and instructions to contact the user via a different messaging channel.

13. (canceled)

14. The system of claim 11, wherein the program further instructs the processor to perform:
comparing the communication load of the user to a predetermined threshold; and
when the communication load is at or exceeds the predetermined threshold, declining or queueing a request to initiate a new communication session with the user.

15. The system of claim 11, wherein the plurality of parameters further comprises at least one of a priority of a party involved in at least one of the current communication sessions, a complexity of at least one of the current communication sessions, or a current location of the user.

16. The system of claim 11, wherein the program further instructs the processor to perform:
receiving, from at least one wearable device associated with the user, health data related to a current health status of the user, wherein the plurality of parameters further comprises one or more physiological parameters extracted from the health data.

17. The system of claim 11, wherein an engagement level of the user in a meeting is determined based on one or more of a role of the user in the meeting, a number of active speaking instances by the user, and a number of times the user is mentioned by another participant.

18. The system of claim 11, wherein the program further instructs the processor to perform:
creating a profile for the user, the profile comprising at least one of a title or a function of the user; and
determining, based on the profile, the subset of the plurality of parameters.

19. The system of claim 11, wherein the program further instructs the processor to perform:
receiving, from the user, instructions to customize the subset of the plurality of parameters.

20. The system of claim 11, wherein the user comprises one of a plurality of users and wherein the program further instructs the processor to perform:
generating a report relating to the communication load for the plurality of users over a defined time period.

21. The method of claim 1, wherein the at least one color comprises two or more colors and wherein the appearance of the status indicator comprises one of:
a first solid color in a first portion of the status indicator and a second solid color in a section portion of the status indicator;
a mix of two colors; or
a gradient of two colors.

22. The system of claim 11, wherein the at least one color comprises two or more colors and wherein the appearance of the status indicator comprises one of:
a first solid color in a first portion of the status indicator and a second solid color in a section portion of the status indicator;
a mix of two colors; or
a gradient of two colors.
